(19) United States
(12) Patent Application Publication
(10) Pub. No.: US 2025/0368235 A1
(43) Pub. Date: Dec. 4, 2025

(54) DEVICE AND A METHOD FOR MINIMIZING THE EFFECTS OF GLARE OF A DRIVER OF A VEHICLE

(71) Applicants: Cornelius BUERKLE, Karlsruhe (DE); Fabian OBORIL, Karlsruhe (DE)

(72) Inventors: Cornelius BUERKLE, Karlsruhe (DE); Fabian OBORIL, Karlsruhe (DE)

(21) Appl. No.: 19/220,143

(22) Filed: May 28, 2025

(30) Foreign Application Priority Data
Jun. 4, 2024 (DE) 102024115521.3

(51) Int. Cl. B60W 60/00; B60K 35/40; B60Q 1/14; B60W 40/08; G06V 40/18

(52) U.S. Cl. CPC B60W 60/0051; B60K 35/415; B60Q 1/1423; B60W 40/08; G06V 40/18; B60Q 2300/056; B60W 2040/0818; B60W 2420/403

(57) ABSTRACT

A device for minimizing the effects of glare of a driver of a vehicle is proposed. The device comprises a circuit configured to determine a glare intensity of the glare of the driver of the vehicle. The circuit is further configured to activate an in-vehicle safety function to increase driving safety in the presence of glare if the glare intensity exceeds a threshold.

### BACKGROUND

In order to increase vehicle safety and achieve higher ratings in safety tests, vehicle headlights have become continuously brighter in the past. Furthermore, vehicle headlights are increasingly used, inter alia, with LEDs which emit blue light, instead of vehicle headlights based, for example, on standard light bulbs which have a warmer hue. Furthermore, the vehicle headlights are increasingly used in higher cars with correspondingly higher mounted headlights, and in addition the vehicle headlight adjustment can change by moving the vehicle in traffic. These developments mentioned lead to increased glare increasingly occurring in road users. This glare in road users can lead to dangerous situations and even to accidents. In particular, the loss of control over the vehicle due to glare is problematic.

### BRIEF DESCRIPTION OF THE FIGURES

Some examples of devices and/or methods will be described in the following by way of example only and with reference to the accompanying figures, in which:

FIG. 1 shows a block diagram of an example of a device or apparatus for minimizing the effects of glare of a driver of a vehicle;

FIG. 2 shows a flow chart of an example of a method for minimizing the effects of glare of a driver of a vehicle;

FIG. 3 shows, by way of example, a system of the disclosed technology for minimizing the effects of glare of a driver of a vehicle;

FIG. 4 shows, by way of example, a glare evaluator;

FIG. 5 shows, by way of example, the determination of a glare cause;

FIG. 6 shows, by way of example, the driver assistance emergency control system;

FIG. 7 shows, by way of example, the function of a light configurator in case of self-glare;

FIG. 8 shows a block diagram of an example of a device or apparatus for minimizing the effects of glare of a following vehicle by a preceding vehicle;

FIG. 9 shows a flow chart of an example of a method for minimizing the effects of glare of a following vehicle by a preceding vehicle.

FIG. 10 shows a block diagram of an example of a device or apparatus for minimizing the effects of glare in an area outside the field of view of a vehicle;

FIG. 11 shows a flow chart of an example of a method for minimizing the effects of glare in an area outside the field of view of a vehicle;

FIG. 12 shows a block diagram of an example of a device or apparatus for adjusting a light intensity of a front headlight of a vehicle; and

FIG. 13 shows a flow chart of an example of a method 1300 for adjusting a light intensity of a front headlight of a vehicle.

### DESCRIPTION

Some examples are now described in more detail with reference to the enclosed figures. However, other possible examples are not limited to the features of these embodiments described in detail. These may include modifications of the features as well as equivalents and alternatives to the features. Furthermore, the terminology used herein to describe certain examples should not be restrictive of further possible examples.

Throughout the description of the figures, same or similar reference numerals refer to same or similar elements and/or features, which may, in each case, be identical or implemented in a modified form while providing the same or a similar function. The thickness of lines, layers and/or areas in the figures may also be exaggerated for clarification.

When two elements A and B are combined using an ‘or’, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a,” “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may also be practiced without these specific details. Known circuits, structures and techniques have not been described in detail so as not to impair the understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and point to different instances of like elements being referred to. Such adjectives do not mean that the elements so described must be in a given sequence, either temporally or spatially, in ranking, or in any other manner. “Connected” may mean that the elements are in direct physical or electrical contact with each other, and “coupled” may mean that the elements cooperate or interact with each other, but they may or may not be in direct physical or electrical contact.

As used herein, the terms “operate,” “execute,” or “run,” when referring to software or firmware with respect to a system, device, platform, or resource, are used interchangeably and may refer to software or firmware stored on one or more computer-readable storage media accessible by the system, device, platform, or resource, even if the instructions included in the software or firmware are not being actively executed by the system, device, platform, or resource.

In the description, the terms “in an example/example,” “in examples/examples,” “in some examples/examples,” and/or “in various examples/examples” may be used, each of which may refer to one or more like or different examples. Moreover, the terms “comprising,” “including,” “with,” and the like, as used with respect to the examples of the present disclosure, are synonymous.

As described above, glare increasingly occurs in road users due to modern vehicle headlights, which can lead to dangerous situations and accidents.

In previous approaches, headlights with adaptive vehicle headlight systems and light beams have been used by vehicle manufacturers (e.g., automotive manufacturers). Attempts are made to detect other road users or vehicles and, e.g., to deactivate the high beam for certain areas. That is, the light control unit of the vehicle activates/deactivates the high beam and/or entire light areas are turned on/off with the aid of matrix LED systems or variable shades. These systems can detect road users (e.g., other cars, cyclists and pedestrians) and switch off the illumination of these areas with the high beam or, e.g., illuminate a pedestrian on the sidewalk at night in a targeted manner. However, glare also occurs due to the low beam (standard light). Moreover, glare not only occurs due to headlights of other vehicles, but also due to self-glare of the own vehicle, e.g., due to reflections of the emitted light of the vehicle headlights. The result is that the brighter vehicle lights significantly increase the probability of a loss of control. Furthermore, each driver is differently sensitive, e.g., the risk of being exposed to temporary glare from oncoming traffic increases considerably with increasing age. Furthermore, in the case of glare, strong light can also have a lasting negative effect for the human eye and for cameras (e.g., the effects of light on camera sensors and human eyes can be shown by means of (learning-based) models).

Other previous approaches describe different functions of advanced driver assistance systems (ADAS) or functions of autonomous driving (AD). For example, in some new vehicles, e.g., a lane keeping assistant and the sensors required therefor (e.g., the front camera) are standard.

A disadvantage of these previous approaches of front light adaptation is that, in normal driving situations, they focus only on the activation/deactivation of the high beam, wherein low beams can also cause glare. Especially if the vehicles are located close to one another and at different heights. Moreover, these previous approaches are reactive, i.e., the light is switched off only if it detects another road user, but does not adapt the settings proactively, e.g., in front of crests/crests or curves. In these cases, the reactive system is often too slow and leads to instantaneous glare. Finally, the previous approaches only use binary on/off decisions, but do not adapt the light intensity or take into account how a driver personally perceives the light.

The present disclosure presents a device and a method (e.g., implemented in a driver assistance system or in an autonomous driving system) that comprises a component that is configured to determine the extent of glare of the driver with the aid of an adapted driver monitoring system. Further, the device and the method comprise a component for determining the cause of the glare of the driver that can initiate countermeasures, e.g., the reduction of the light intensity of the own vehicle headlight if the glare cause is a reflection of the vehicle headlight (e.g., at a traffic sign or a glass front). Further, the disclosed technology mitigates the effects of the glare of the driver (e.g., due to strong vehicle lighting of a second vehicle) (e.g., in particular during driving in the dark with high contrast and intensity differences). Further, the device and the method comprise a driver assistance system emergency control system that can deprive the driver of control over the vehicle for a short time when strong glare of the driver is detected in order to prevent the driver from losing control over the vehicle.

The disclosed technology has the advantage that traffic safety is improved by activating the in-vehicle safety function during glare of the driver. As a result, the probability of accidents that occur in particular due to control losses during glare of the driver decreases. This applies in particular in contexts in which the glare of the driver with higher probability leads to a loss of control, e.g., during night driving or in the event that the driver is overly tired. Both the driver of the vehicle and the other road users and the vehicle manufacturers benefit from this.

Known driver monitoring systems (DMS) are not able to detect glare of the driver. Current driver monitoring systems would classify a driver as fully attentive even if the person is exposed to glare for a few seconds due to a strong oncoming light source. This is due to the fact that the subjective influence of light in the dark is not taken into account by current driver monitoring systems. Furthermore, currently known driver assistance systems or functions of autonomous driving are configured such that whenever the driver steers, brakes or accelerates, the corresponding driver assistance system or autonomous driving system is deactivated or overwritten by the human control input. In the technology proposed here, a driver assistance system (or autonomous driving system) emergency control system ensures that the human control inputs are ignored and, if the driver assistance system or autonomous driving system was previously deactivated, it is activated again (if this is safely possible). Thus, if the human driver makes an incorrect control input due to temporary glare, this is ignored, and the vehicle is instead controlled by the driver assistance system or autonomous driving system activated by the driver assistance system emergency control system.

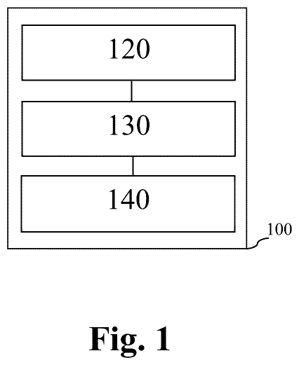

FIG. 1 shows a block diagram of an example of a device 100 or apparatus 100 for minimizing the effects of glare of a driver of a vehicle. The device 100 comprises circuits configured to provide the functionality of the device 100. For example, device 100 of FIG. 1 comprises (optionally) an interface circuit (interface) 120, a processing circuit (processor) 130 and (optionally) a memory circuit (memory) 140. The processing circuitry 130 may be coupled to, e.g., the interface circuitry 120 and optionally to the memory circuitry 140.

For example, the processing circuit 130 may be configured to provide the functionality of the apparatus 100 in conjunction with the interface circuit 120. For example, the interface circuit 120 is configured to exchange information, e.g., with other components inside or outside the apparatus 100 and the memory circuit 140. Likewise, the device 100 may comprise means configured to provide the functionality of the device 100.

The components of the device 100 are defined as means that correspond to or may be implemented by the respective structural components of the device 100. For example, device 100 of FIG. 1 comprises means for processing 130 corresponding to or implementable by the processing circuit 130, means for communicating 120 corresponding to or implementable by the interface circuit 120 and (optionally) means for storing information 140 corresponding to or implementable by the memory circuit 140. In the following, the functionality of device 100 is described with respect to the apparatus 100. Features described in connection with the apparatus 100 may thus also be transferred to the corresponding apparatus 100.

In general, the functionality of the processing circuit 130 or the processing device 130 may be implemented by the processing circuit 130 or the processing device 130 executing machine-readable instructions. Accordingly, any function attributed to the processing circuitry 130 or the processing means 130 may be defined by one or more instructions from a plurality of machine-readable instructions. The apparatus 100 or the device 100 may comprise the machine-readable instructions, for example, within the memory circuit 140 or within the means for storing information 140.

The interface circuit 120 or the communication means 120 may correspond to one or more inputs and/or outputs for receiving and/or transmitting information, which may be present in digital (bit) values according to a certain code within a module, between modules, or between modules of different entities. For example, the interface circuit 120 or the communication means 120 may comprise a circuit configured to receive and/or transmit information.

The processing circuit 130 or the processing means 130 may, for example, be implemented using one or more processing units, one or more processing devices, any means for processing, such as a processor, a computer, or a programmable hardware component, which may be operated with accordingly adapted software. In other words, the described function of the processing circuit 130 or the processing means 130 may as well be implemented in software, which is then executed on one or more programmable hardware components. Such hardware components may be a general-purpose processor, a digital signal processor (DSP), a microcontroller, etc.

The memory circuit 140 or the means for storing information 140 may comprise, for example, at least one element from the group of computer-readable storage media, such as a magnetic or optical storage medium, e.g., a hard disk drive, a flash memory, a floppy disk, a random access memory (RAM), a read-only memory (ROM), a programmable read-only memory (PROM), an erasable programmable read-only memory (EPROM), an electronically erasable programmable read-only memory (EEPROM), or a network memory.

The processing circuit 130 is configured to determine a glare intensity of the glare of the driver of the vehicle. The glare of the driver denotes, for example, the visual impairment of the driver that is caused by a sudden, strong light exposure of the driver and impairs the ability of the driver's eye to capture and process clear images. For example, glare occurs when bright light is incident on the driver's eye and the pupil cannot be narrowed quickly enough to reduce the amount of light. This leads to a temporary overload of the light-sensitive cells in the retina and can lead to a temporary impairment of the visual performance of the driver. Physiologically, glare can lead to a temporary restriction of the driver's vision, a reduced contrast perception of the driver, a longer reaction time of the driver and/or a temporary loss of control of the driver over the vehicle if the driver is not able to process clear visual information and react appropriately. Causes of glare can be, for example, glaring sunlight, reflections of the vehicle headlight at a road sign, the road surface or the vehicle surroundings, a traffic light or the like, glaring headlights of oncoming vehicles, or road lighting.

The vehicle can be a means of transport serving for the movement of persons or goods and can be a car, motorcycle, truck, bus, train, ship or airplane or the like.

The glare intensity denotes, for example, the intensity of the visual impairment exerted on the viewer by a glare source. The glare intensity is a measure of the intensity of the visual impairment exerted on the driver by a glare source. It can be generally defined as the amount of light that enters the eye and impairs the ability of the eye to capture and process clear images. This glare intensity depends, for example, on various factors including the brightness of the light source, the distance to the light source, the viewing angle and the sensitivity of the driver's eye. The glare intensity can depend, for example, on various physical variables such as the light intensity (measured in candela), the luminous intensity (measured in candela), the illuminance (measured in lux) or the luminance (measured in candela per square meter).

The glare intensity of the glare of the driver can be based, for example, on data of one or more driver monitoring sensors. Driver monitoring sensors capture various aspects of the driver's condition and the surroundings. The captured sensor data can be further processed by a circuit to determine the glare intensity of the glare of the driver. For example, a driver monitoring sensor is configured as a vehicle interior camera which monitors the driver of the vehicle, for example by capturing his eye movements, viewing direction and facial expressions, etc. For example, based on the captured sensor data of the driver monitoring sensor, a pupil opening of the driver, a blink frequency of the driver, a gaze direction of the driver, a gesture for protection against glare of the driver, the presence of tears and environmental information such as light sources and reflections are determined.

Furthermore, the processing circuit 130 is configured to activate an in-vehicle safety function to increase driving safety if the glare intensity exceeds a threshold. For example, when the glare intensity threshold is exceeded, the in-vehicle safety function to increase driving safety can be activated. The in-vehicle safety function to increase driving safety in the case of glare of the driver comprises, for example, a control function of the vehicle which increases the safety of the vehicle in case of glare of the driver. In this case, the in-vehicle safety function to increase driving safety can reduce the intensity of the glare and/or reduce potential consequences of the glare of the driver.

For example, the in-vehicle safety function to increase driving safety comprises a driver assistance system or an autonomous driving system. In this case, the driver assistance system or autonomous driving system controls, for example, at least one function of the vehicle during a first time period. That is, activating the in-vehicle safety function to increase driving safety comprises, for example, activating the driver assistance system or autonomous driving system or and, thus, activating the control of at least one function of the vehicle during the first time period. In another example, activating the in-vehicle safety function to increase driving safety comprises adjusting a light intensity in a part of a light emission range of a headlight of the vehicle. For example, this in-vehicle safety function to increase driving safety is activated if a self-glare by the vehicle (for example, at a traffic sign or a traffic light or the like) has been determined as the cause of the glare of the driver. In a further example, activating the in-vehicle safety function to increase driving safety comprises informing a second vehicle about the determined glare intensity if a glare by a headlight of the second vehicle has been determined as the cause of the glare of the driver. The first time period relates, for example, to a time period during which the driver is not able to exercise full and safe control over the vehicle. The first time period can be determined by the processing circuit 130 as a function of the glare intensity, a previous glare load of the driver (depending on a personal state such as age, fatigue, etc.), a predicted duration of the glare of the driver, a glare recovery duration of the driver and/or environmental factors (day/night, weather conditions, etc.).

The disclosed technology has the advantage that traffic safety is improved by activating the in-vehicle safety function during glare of the driver. As a result, the probability of accidents that occur in particular due to control losses during glare of the driver decreases. This applies in particular in contexts in which the glare of the driver with higher probability leads to a loss of control, e.g., during night driving or in the event that the driver is overly tired. Both the driver of the vehicle and the other road users and the vehicle manufacturers benefit from this.

### Determining the Glare Intensity

As described above, for example, determining the glare intensity is based on a state of the pupil opening of the driver, a blink frequency of the driver, a gaze direction of the driver, a glare protection gesture of the driver, a presence of tears in an eye of the driver and/or information about the surroundings of the vehicle (some or all of the information mentioned are also referred to as driver condition and environmental information). The state of the pupil opening of the driver describes, for example, the size of one or both pupils of the driver. This reveals how strongly the driver's eye is exposed to the light, wherein a strong narrowing indicates, for example, a high light intensity and potential glare. The blink frequency describes the frequency of the driver blinking his eyes. An increased blink frequency can indicate that the driver is trying to protect his eyes from excessive light or to humidify them, which indicates an increased glare intensity. The gaze direction of the driver describes eye movements and/or head position of the driver. If it is determined that the driver is turning away from a certain direction, for example, the direction of travel, this indicates glare. The glare protection gesture of the driver relates, for example, to actions such as holding a hand or an arm or another object in front of the eyes or folding down the sun visor. This indicates that the driver is trying to protect himself from a glaring light source. The presence of tears in one or both eyes of the driver relates, for example, to the fact that the production of tears indicates a reaction to excessive light exposure. This indicates that the eyes are overstressed or irritated by glare. Information about the surroundings of the vehicle relates, for example, to data about external light sources, such as oncoming or preceding vehicles, reflections of wet roads, traffic signs or glass facades and weather conditions such as sunshine or rain.

In some examples, the processing circuit 130 is further configured to determine the state of the pupil opening of the driver, the blink frequency of the driver, the gaze direction of the driver, the glare protection gesture of the driver and/or the presence of tears in an eye of the driver based on data of at least one sensor inside the vehicle directed at the driver. The sensor can be, for example, a driver monitoring sensor. For example, the sensor can be an optical sensor, for example an infrared sensor, an RGB camera, a time-of-flight sensor, a lidar sensor, etc. In some examples, a plurality of sensors can be used and the corresponding sensor data can be fused to determine the variables mentioned (sensor fusion). The data captured by one or more sensors such as an infrared camera, RGB camera and time-of-flight sensor or lidar sensor comprise infrared images, color images and 3D depth images. This raw data can be analyzed by known image processing and image recognition algorithms to obtain information about the driver's condition. These algorithms can comprise classical image processing algorithms, such as the Hough transform algorithm and geometric eye recognition, as well as machine learning methods. These algorithms make it possible to precisely determine the pupil opening, blink frequency, gaze direction, protection gestures and the presence of tears.

In some examples, the processing circuit 130 is further configured to determine information about the surroundings of the vehicle based on at least one environmental sensor of the vehicle. In some examples, a plurality of environmental sensors can be used and the corresponding environmental sensor data can be fused to determine information about the surroundings of the vehicle (sensor fusion). Information about the surroundings of the vehicle comprises the position and distance of obstacles, the recognition and classification of other vehicles, pedestrians or animals, the determination of the lane and the roadway condition, as well as the detection of traffic signs and traffic lights or the like. The at least one environmental sensor can be configured as a radar, lidar, ultrasound, or camera sensor. The data captured by one or more environmental sensors such as radar, lidar, ultrasound and cameras comprise distance information, speeds, 3D depth images and visual images of the surroundings. This raw data can be analyzed by known image processing and image recognition algorithms to obtain information about the surroundings of the vehicle. These algorithms can comprise classical image processing algorithms as well as machine learning methods. These algorithms make it possible to precisely determine the position and distance of obstacles, the recognition and classification of vehicles and pedestrians, the lane and roadway condition as well as traffic signs and traffic lights.

In some examples, the processing circuit 130 is further configured to determine the state of the pupil opening of the driver, the blink frequency of the driver, the gaze direction of the driver, the glare protection gesture of the driver, the presence of tears in an eye of the driver and/or to determine information about the surroundings of the vehicle based on a machine learning algorithm. Machine learning comprises different classes of algorithms for processing environmental and driver sensor data in the vehicle. For example, supervised learning algorithms, unsupervised learning algorithms can be used. Supervised learning comprises algorithms such as support vector machines (SVMs) and random forests trained to recognize specific patterns and objects in the data. Unsupervised learning includes algorithms such as k-means clustering that can be used to identify patterns and structures in the data without having them previously labeled.

For example, for the recognition and classification of obstacles and vehicles, convolutional neural networks (CNNs) can be used that are particularly effective in the analysis of image and video data and in the object recognition, classification and behavior analysis. CNNs such as YOLO (You Only Look Once) can recognize and classify objects in real time. Support vector machines (SVMs) can be used for lane detection by analyzing lines and patterns in the image data. Random forests are well suited for the recognition of traffic signs and traffic lights by the analysis of features and patterns in the image data. In the monitoring of the driver's condition, CNNs can be used for the analysis of the pupil opening and blink frequency by continuously monitoring the eye area. Algorithms such as the Hough transform and SVMs can be used to precisely determine the gaze direction of the driver. Gesture recognition can be performed by algorithms such as random forests and YOLO to identify protection gestures such as holding the hand in front of the eyes. The presence of tears can be determined by CNNs and image processing algorithms such as the histogram of oriented gradients (HOG). These machine learning algorithms are, for example, trained on large data sets that cover different scenarios and conditions in road traffic as well as different driver conditions. For example, for the training of algorithms for the recognition of obstacles and other vehicles and vehicles, an annotated data set is used that includes images of roads with and without obstacles as well as under different weather and light conditions. Algorithms for the monitoring of the driver's condition, such as the analysis of the pupil opening and blink frequency, are trained with data sets that include different eye movements, blink patterns and pupil responses in different lighting conditions. The gaze direction recognition requires annotated images that represent the eye position and head movements of the driver in different scenarios. Gesture recognition is supported by training data sets that show different hand and arm movements in front of the driver's face. Finally, algorithms for the recognition of tears are trained with images that represent different degrees of eye wetness and reflections.

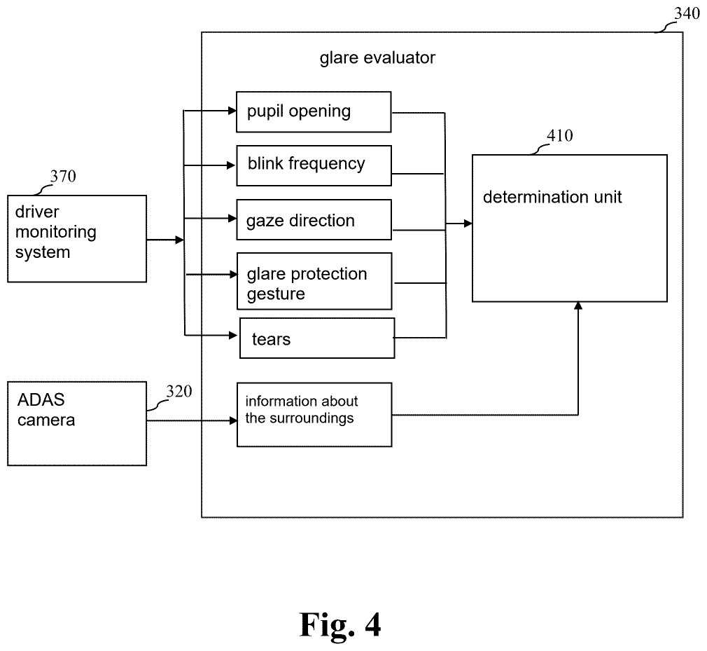

In some examples, the determined driver condition and environmental information can be further processed by the processing circuit 130 to determine the glare intensity of the glare of the driver (see also the determination unit 410 in FIG. 4).

In some examples, determining the glare intensity is based on a weighted combination of the state of the pupil opening of the driver, the blink frequency of the driver, the gaze direction of the driver, the glare protection gesture of the driver, the presence of tears in an eye of the driver and/or information about the surroundings of the vehicle. That is, a linear combination that is formed by some or all of the determined driver condition and environmental information, that is, some or all of the driver condition and environmental information mentioned, can be multiplied by a weighting factor (weight) and then added. In another example, a convex combination of the determined driver condition and environmental information can be formed, wherein the sum of the weights is always 1. The driver condition and environmental information mentioned can, for example, be normalized to a specific value range, for example 0 to 1. In another example, the glare intensity is normalized to a specific value range, for example 0 to 1 (see below).

In some examples, determining the glare intensity is based on a machine learning algorithm and the state of the pupil opening of the driver, the blink frequency of the driver, the gaze direction of the driver, the glare protection gesture of the driver, the presence of tears in an eye of the driver and/or information about the surroundings of the vehicle. That is, the (trained) machine learning algorithm obtains all or parts of the driver condition and environmental information mentioned above as input data and outputs the determined glare intensity as an output value. For example, artificial neural networks (ANNs) can be used as machine learning. For example, recurrent neural networks (RNNs) can be used that are specialized in processing sequences of data and modeling temporal dependencies. In particular, long short-term memory networks (LSTMs) can be used that are specialized in recognizing long-term dependencies and storing information over longer periods of time and are thus particularly suitable for determining the glare intensity based on the driver condition and environmental information. The training of the LSTM network is performed, for example, with extensive, annotated data sets that cover different driving conditions and environmental conditions. Applied in real time, the trained LSTM network enables a precise determination of the glare intensity.

In some examples, the determination of the glare intensity is based on a look-up table or the like.

Since the effects of blindness and in particular the duration of the recovery from blindness is different for each driver and can also depend on how long the driver is already driving the car, the determination of the glare intensity can be performed (for example, by machine learning) in a self-learning/self-adapting manner to determine the effects and the duration of the glare of the driver, including the determination of the driver condition and environmental information.

### Activating the Driver Assistance System or Autonomous Driving System

As described above, activating the in-vehicle safety function to increase driving safety comprises activating the driver assistance system or autonomous driving system. In this case, the driver assistance system or autonomous driving system controls, for example, at least one function of the vehicle during a first time period. In some examples, activating the driver assistance system or autonomous driving system comprises activating an adaptive cruise control of a lane keeping assistant, a collision avoidance assistant and/or an emergency braking assistant. The emergency braking assistant detects, for example, that a collision of the vehicle with another vehicle is unavoidable and actuates the brakes of the vehicle on its own in order to reduce the severity of the collision or to avoid it entirely. The collision avoidance assistant can, for example, control the vehicle autonomously in order to avoid an obstacle while at the same time ensuring the driving stability. The lane keeping assistant can, for example, intervene correctively if the vehicle threatens to leave its lane in order to keep the vehicle safely in the lane. The adaptive cruise control can, for example, adapt the speed of the vehicle, either by slowing or in some cases by accelerating, in order to avoid a potential hazard.

In some examples, the driver assistance system supports the driver during the first time period, but the driver maintains control over the vehicle. That is, the driver can overwrite the control proposed by the driver assistance system with respect to the at least one function of the vehicle with a control command (for example, the actuation of the accelerator pedal or the steering wheel).

In some examples, the processing circuit 130 is further configured to block control commands of the driver with respect to the at least one function of the vehicle during activating the driver assistance system or autonomous driving system for the duration of the first time period. That is, if the driver attempts to overwrite the control proposed by the driver assistance system or autonomous driving system with respect to the at least one function of the vehicle with his control signal (for example, the actuation of the accelerator pedal or the steering wheel), this control signal of the driver is blocked and/or ignored and not forwarded to the responsible control unit of the vehicle. In this case, the driver assistance system or autonomous driving system thus has control over the at least one function of the vehicle during the first time period. For example, the driver assistance system or autonomous driving system comprises a driver assistance system emergency control system. The driver assistance system emergency control system relates, for example, to a safety system in the vehicle that is configured to temporarily take control over certain vehicle functions in dangerous situations in which the driver may not be able to react appropriately. For example, the driver assistance system emergency control system (or an autonomous driving system an autonomous driving emergency control system) ensures that a control signal of the driver is blocked and/or ignored (for example, the driver assistance system emergency control system is an advanced driver assistance system (ADAS) emergency overwrite) and thus transfers control over certain vehicle functions to the driver assistance system in a compulsory manner. The driver assistance system emergency control system thus overwrites the control commands of the driver.

As set forth above, the first time period describes, for example, a time period during which the driver is not able to exercise full and safe control over the vehicle. In some embodiments, the processing circuit 130 is further configured to determine the first time period based on the determined glare intensity, a previous glare load of the driver, a predicted duration of the glare of the driver, a glare recovery duration of the driver and/or environmental factors (day/night, weather conditions, etc.). The previous glare load of the driver relates, for example, to the cumulative exposure of the driver to glare within a certain time window (e.g., within the last 2 or 4 or 8 hours) or within the current drive. This takes into account how often and how intensely the driver has been exposed to glare recently, which can provide an indication of how severely his vision is already impaired. The glare recovery duration of the driver relates, for example, to the time that the driver needs to recover from glare and to regain his full vision. This duration can vary and depends on individual factors such as age, health and fatigue. The glare recovery duration can depend, for example, on the glare intensity and last longer the stronger the glare intensity is. For example, the glare recovery duration of the driver can be a fixed time period, which is scaled with a factor depending on the glare intensity. The environmental factors relate, for example, to external conditions that can influence the glare and its effects. These include the time of day (day/night), weather conditions (rain, fog, snow, sunshine), road condition (wet or slippery roads) and ambient light (road lighting and other light sources) or the like.

The predicted duration of the glare of the driver relates, for example, to an expected time period during which the driver will continue to be exposed to glare. In some examples, the processing circuit 130 is further configured to determine the predicted duration of the glare of the driver based on a cause of the glare of the driver. For example, the processing circuit 130 can determine a predicted duration of the glare of the driver in a look-up table for a specific cause of the glare. If the cause of the glare is an oncoming vehicle, based on data of an environmental sensor of the vehicle (see below), the position and approach speed and the distance can be determined and, together with knowledge of the speed and position of the own vehicle, the predicted duration of the glare of the driver can be determined.

For example, the first time period is determined as the sum of the predicted duration of the glare of the driver and the determined glare recovery duration of the driver, wherein one or both summands are weighted with one of the factors depending on the glare intensity.

In some examples, the first time period is determined as the sum of the predicted duration of the glare of the driver, the determined glare recovery duration of the driver and a glare load time period. The glare load time period depends, for example, on the previous glare load of the driver. For example, the glare load time period is a certain percentage (0.1%, 0.5% or 1%) of the previous cumulative exposure of the driver to glare. The glare load time period can further be weighted by the environmental factors and extend in the case of bad weather conditions or at night. Some or all three summands can be weighted with one of the factors depending on the glare intensity.

In the following, an embodiment for determining the first time period is set forth: The duration of a possible loss of control, i.e., the first time period t_{blind}, which takes into account both the glare intensity and the consequences for the driver, is to be estimated. In this case, both the glare intensity i_{blind} and the glare recovery duration of the driver (time until recovery) t_{recover} are taken into account. Moreover, the previous glare load of the driver (how long the driver has already been exposed to glare) t_{past_exposure} and the predicted duration of the glare of the driver (how long the glare is expected to continue) t_{predict} are taken into account. The first time period t_{blind} is then calculated as follows according to this embodiment:

$${t}_{blind} = f ( {i}_{blind} , {r}_{adapt} ) ( {t}_{past\_exposure} + {t}_{predict} ) + {t}_{recover} \qquad ( 1 )$$

The glare recovery duration of the driver t_{recover} itself depends on the glare intensity i_{blind}:

$${t}_{recover} = g ( {i}_{blind} , {r}_{recover} ) {t}_{recover , base} \qquad ( 2 )$$

That is, the stronger the glare intensity i_{blind} or the longer the exposure, the longer the possible duration of the loss of control.

The two functions f and g serve for the determination of the weighting factor. Both functions have, for example, a sigmoidal form (sigmoid function). The functions f are, for example, as follows:

$$f ( i , r ) = \{ \begin{matrix}0 , if i < {i}_{tollerable} \\ \frac{i}{r} , if i < {i}_{max} \\ \frac{{i}_{max}}{r} , else\end{matrix} \qquad ( 3 )$$

The same applies for the function g. That is, below the glare intensity threshold i_{tollerable}, the weighting factor is 0. With low glare intensity i_{blind} above the glare intensity threshold i_{tollerable}, the weighting effect is low, then it increases with increasing glare intensity i_{blind}, until it finally reaches saturation at iₘₐₓ. This determines whether the driver of the vehicle can adjust to the light change and how long it takes. As long as the glare intensity is tolerable (i.e. no strong glare), the result is consequently 0. If the intensity is above a maximum adjustable intensity iₘₐₓ, a maximum weighting factor is applied, and in between it scales linearly with the intensity. The respective factors r_{adapat} and r_{recover} take into account the adjustment response of the eye.

### Cause of Glare

In some examples, the processing circuit 130 is further configured to determine the cause of the glare of the driver. A cause of the glare of the driver may be, for example, the direct irradiation of sunlight, the exposure of a headlight of oncoming or preceding vehicles, reflections of an own vehicle headlight at a road sign, the road surface of wet surfaces, traffic signs, glass facades, snow, the irradiation of intense light from street lamps, traffic lights or advertising panels or the like. Determining the cause of the glare of the driver may, in some examples, be based on data of at least one environmental sensor of the vehicle. An environmental sensor is, for example, a sensor of the vehicle which is used to collect information about the external conditions around the vehicle, such as light conditions, temperature, humidity, and other relevant environmental data. Examples of such sensors are light sensors which detect brightness and light sources, rain sensors which detect the wetness on the windshield, and optical sensors such as cameras, radar, lidar, and time-of-flight sensors which provide detailed visual information about the surroundings.

To determine the cause of the glare of the driver, the data of the at least one or more environmental sensors of the vehicle may be further processed by the processing circuit 130 (or another circuit inside or outside the vehicle). For example, a light sensor may measure the intensity and direction of the light in order to determine whether the glare is caused by direct sunlight or by the headlights of oncoming or following vehicles. For example, a camera sensor may detect headlights of an oncoming vehicle and the position of the vehicle while a radar sensor determines the approach speed and the distance of the vehicle. If an optical sensor detects strong reflections of the vehicle headlight from wet roads or bright surfaces, such as traffic signs or traffic lights, these may be identified as sources of the glare and thus a self-glare of the vehicle can be identified. If a radar and/or lidar sensor identifies an object in the vicinity of the vehicle and a light sensor simultaneously detects a high light intensity, the processing circuit 130 may conclude that the glare is caused by reflections of the own vehicle headlight at this object. For example, if a lidar sensor detects a large sign in the vicinity and light sensors measure a strong reflection of the vehicle headlight from this sign, the glare is identified as originating from the own headlight. By combining this sensor data, the vehicle can precisely determine which specific cause results in the glare.

In some examples, determining the cause of the glare of the driver is based on data of at least one vehicle assistance system sensor. That is, already existing sensors of the vehicle for the driver assistance system or autonomous driving system may be used to determine the cause of the glare of the driver without having to install additional sensors. For example, the vehicle assistance system sensors include radar, lidar, and camera sensors. These sensors, for example, continuously detect the surroundings of the vehicle, including the position and speed of objects and vehicles as well as the lane markings. The same sensor data may be used to determine the cause of the glare. For example, the cameras which are used for lane keeping may also detect reflective surfaces or glare light sources. Radar and lidar sensors which are used for the distance control and emergency braking may also detect oncoming vehicles, their distance and speed, and their headlights. Thereby, the vehicle assistance system may analyze the sources of the glare without additional sensors.

As described above, in some examples, activating the in-vehicle safety function to increase driving safety comprises adjusting a light intensity in a part of a light emission range of a headlight of the vehicle if a self-glare of the driver by the vehicle has been determined as the cause of the glare of the driver. Self-glares may originate, for example, from reflections of the vehicle headlight at a road sign, the road surface, a traffic light or the like. The light emission range of the headlight of the vehicle relates, for example, to the area in front of the vehicle which is illuminated by the headlights. This area comprises all angles and distances which can be covered by the light beams of the headlights. For example, the headlight comprises numerous individually controllable LEDs or other light sources which are arranged in a grid or array. By selectively driving individual light sources, the light emission range can be precisely controlled to illuminate or darken certain areas of the road. For example, if a self-glare of the driver is recognized by reflections of the headlight, the processing circuit 130 can dim or switch off individual LEDs which are responsible for the interfering reflection and thus the glare. At the same time, other LEDs may illuminate more intensively to ensure that the road continues to remain optimally illuminated.

In some examples, the processing circuit 130 is further configured to inform a second vehicle about the determined glare intensity. The second vehicle was, for example, determined as the cause of the glare of the driver. For example, the second vehicle is informed if the determined glare intensity exceeds a predetermined threshold. For example, the processing circuit 130 can communicate with the second vehicle via the interface 120, wherein the interface is, for example, configured as a vehicle-to-vehicle (V2V) interface. The second vehicle then receives the information about the glare caused and can respond thereto by, for example, adjusting the light intensity of its headlights or dimming specific light segments to reduce the glare. This cooperative interaction helps to increase the immediate safety of the driver exposed to glare and to improve overall traffic safety by vehicles collectively creating a safe and comfortable driving environment.

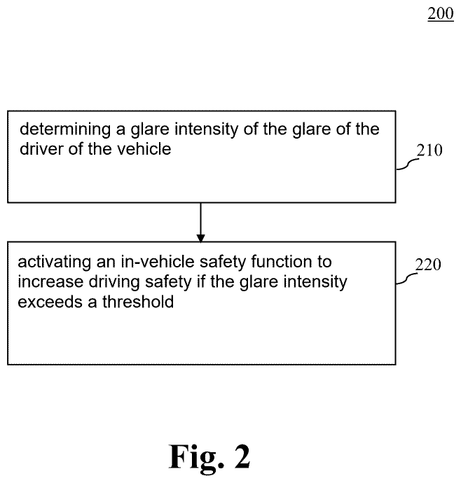

More details and aspects are mentioned in connection with the examples described below. The embodiment shown in FIG. 1 may comprise one or more optional additional features corresponding to one or more aspects mentioned in connection with the proposed concept or an example described below (e. g. FIGS. 2-13).

FIG. 2 shows a flowchart of an example of a method 200 for minimizing the effects of glare of a driver of a vehicle. The method 200 may be performed, for example, by a device described herein, such as the device 100. The method comprises determining 210 a glare intensity of the glare of the driver of the vehicle. The method 200 further comprises activating 220 an in-vehicle safety function to increase driving safety if the glare intensity exceeds a threshold.

Further details and aspects of the method 200 are explained in connection with the proposed technology or one or more examples described above, e.g., with reference to FIG. 1. Method 200 may comprise one or more additional optional features corresponding to one or more aspects of the proposed technology or one or more examples described above.

### Further Example Embodiments

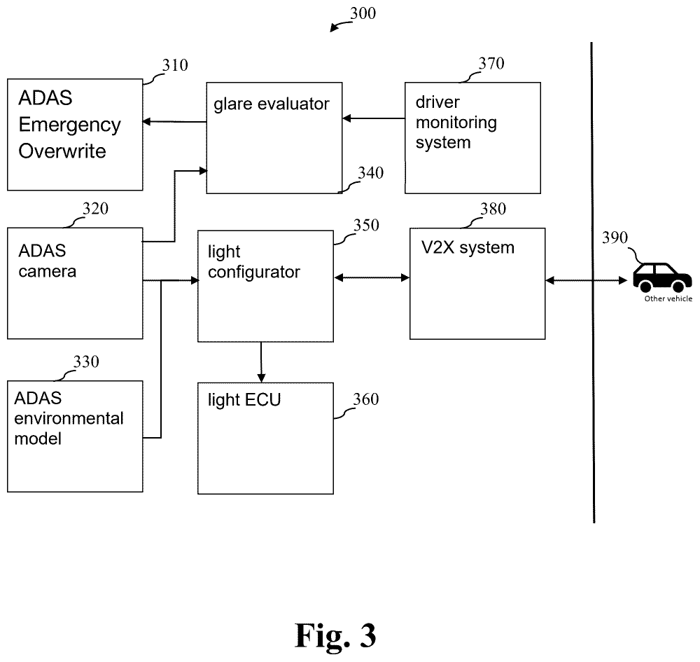

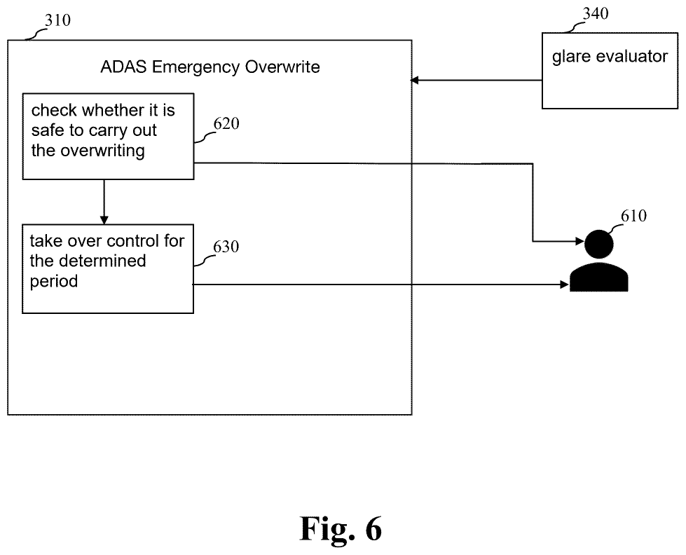

FIG. 3 shows, by way of example, a system 300 of the disclosed technology for minimizing the effects of glare of a driver of a vehicle. The system 300 comprises the modules 310-360 and is a functional representation of the device 100 of FIG. 1 for minimizing the effects of glare of a driver of a vehicle. The driver monitoring system 370 monitors the state of the driver, including factors such as pupil opening, blink frequency and gaze direction, to detect the influence of glare. This information is transmitted to the glare evaluator (340), which also receives data from the driver assistance camera 320 (e.g., an ADAS camera) and the ADAS environmental model (330). The driver assistance camera provides visual data about the surroundings of the vehicle and helps to detect the current traffic situation as well as potential sources of glare, while the ADAS environmental model 330 provides a comprehensive model of the vehicle surroundings to identify other objects and obstacles that could be affected by the vehicle lighting. The glare evaluator 340 analyzes the collected data to determine the glare intensity and determine the cause of the glare (see Fig. X). Should the glare be caused by the own vehicle, the light configurator 350 dynamically calculates the required adjustment of the light intensity. These adjustments are forwarded to the light ECU 360, which takes over the actual hardware control of the headlights and adjusts their light distribution and intensity according to the instructions of the light configurator. This helps to reduce the risk of glare of the own or other drivers. Depending on the determined glare intensity, the glare evaluator 340 determines a first time period within which the driver is exposed to a high level of glare and may lose control of the vehicle. During this first time period, a driver assistance emergency control system 310 (ADAS Emergency Overwrite Module) (see FIG. 6) forcibly activates the driver assistance system (ADAS) or autonomous driving system and hands over control of some vehicle functions to this ADAS system (e.g., lane keeping and adaptive cruise control (ACC)). This helps to improve safety by taking over control until the driver is ready to take full control again. If it is determined that the glare is caused by the headlights of a second vehicle, the V2X module 380 optionally informs the second vehicle 390 about the determined glare intensity. Via vehicle-to-everything (V2X) communication, the second vehicle can adjust its headlights to reduce glare and thus improve driving conditions for all parties involved.

This system can also contribute to improving safety in daylight, e.g., when the vehicle is directly aimed at the sun being low in the sky or when transitioning from a dark area (e.g., a tunnel) to a bright area.

FIG. 4 shows, by way of example, the glare evaluator 340. The glare evaluator 340 receives input data from the ADAS camera 320 and from the driver monitoring system 370. The input data of the driver monitoring system 370 includes the information about the state of the pupil opening of the driver, the blink frequency of the driver, the gaze direction of the driver, a glare protection gesture of the driver (e.g., covering the eyes with the hand or turning the head in oncoming traffic), and/or the presence of tears in an eye of the driver. For example, the driver monitoring system 370 may include a standard driver monitoring camera to monitor the state of the pupil of the driver or the blink frequency, etc. For example, if the pupil quickly closes (and reopens shortly thereafter) in the darkness during driving, this is an indication that the driver is exposed to glare. If a driver is exposed to glare, the blink rhythm changes or tears even form, which can be derived by the driver monitoring system 370 (e.g., from a camera stream) of any standard driver monitoring system.

The aforementioned driver state and environmental information can be recognized using known and retrained machine learning modules. Parts or all of the captured input data are then captured by a determination unit 410 and the glare intensity (i_{blind}) of the glare of the driver is determined. In one example, the determination unit 410 uses an LSTM method to determine the glare intensity. In another example, the determination unit 410 uses a weighted evaluation of the input data (or parts thereof) or a look-up table is used to determine the glare intensity.

An analytical weighting to determine the glare intensity i_{blind} may look as follows:

$${i}_{blind} = {ω}_{1} ∇ {p}_{open} + {ω}_{2} ∇ {f}_{blink} + {ω}_{3} g + {ω}_{4} h + {ω}_{5} t \qquad ( 4 )$$

wherein the weighing factors ωᵢ, i=1, . . . , 5 can be determined in such a way that the various desired influencing factors of the different input data are taken into account (e.g., the formation of tears promptly indicates the highest possible glare intensity). ∇pₒₚₑₙ describes the change in pupil opening, ∇f_{blink} describes the change in blink frequency, g describes the recognized gaze direction, h the recognized glare protection gesture and t for the formation of tears.

The input data may further include information about the surroundings of the vehicle of the ADAS camera 320. This input data may be included to determine the glare intensity i_{blind}. For example, if the illumination algorithm of the ADAS camera has problems with adjusting the settings of a headlight due to the lights of an oncoming vehicle, this may also be taken into account in determining the glare intensity. Further, the amount of light captured by a forward facing ADAS camera could be used as an objective parameter to determine the glare intensity.

In one example, the vehicle may comprise a user interface via which the driver can calibrate the glare evaluator 340 and the other units of the system. In this calibration process, the driver can adjust the sensitivity of the glare evaluator 340 and the other units of the system in such a way that it reacts either earlier or later in order to avoid over-cautious behavior. In other examples, the input data may include further parameters to determine the glare intensity.

Since the effects of the glare and, in particular, the duration of recovery from the glare are specific to each driver and also depend on how long the driver is already driving, the glare evaluator 340 is self-learning/self-adaptive. That is, the effects and the determination of the duration of the glare including a determination of the aforementioned parameters take place dynamically.

The duration of a possible loss of control (the first time period) t_{blind}, the glare recovery duration of the driver (time until recovery) t_{recover}, as well as the previous glare load of the driver (how long the driver was already exposed to the glare) t_{past_exposure} and the predicted duration of the glare of the driver (how long the glare is expected to continue) t_{predict} is determined, for example, as described above in equations (1) to (3).

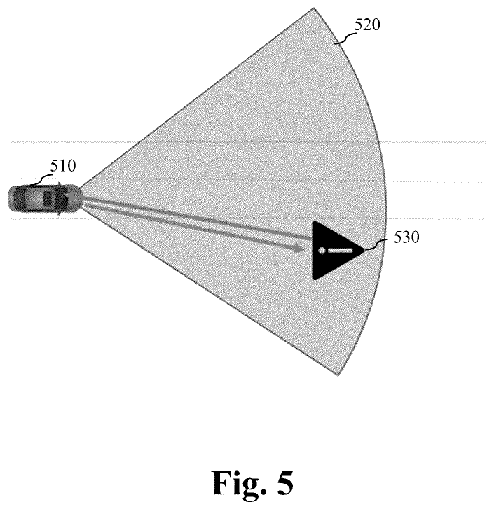

Furthermore, the system 300 is configured to identify the source of glare of the driver. FIG. 5 shows, by way of example, the determination of a cause of glare. The vehicle 510 has the light emission range 520 of the front headlights. Within the light emission range 520 there is a traffic sign 530 which exposes the driver of the vehicle 510 to glare due to a reflection of the front headlight of the vehicle 510. For this purpose, the external sensors (e.g., the ADAS camera 320), for example, are used to detect the reflections. Further, the system 300 is also configured to detect oncoming and following vehicles by means of the external sensors (e.g., the ADAS camera 320). The source of the glare can be identified with knowledge of the position and orientation with respect to the own vehicle as well as information about glare effects of the cameras. If the source is identified, the duration t_{predict} of the glare effect can be determined, for example, on the basis of the relative speed between the own vehicle and the determined glare source.

FIG. 6 shows, by way of example, the driver assistance emergency control system 310 (ADAS Emergency Overwrite Module). The ADAS Emergency Overwrite Module 310 comprises a query a step 620. If the glare intensity exceeds a threshold, the system 300 activates the in-vehicle safety function to increase driving safety. Activating the in-vehicle safety function to increase driving safety comprises activating the driver assistance system emergency control system 310 (ADAS Emergency Overwrite Module). Since the driver 610 can no longer fully perceive the surroundings, the glare may result in a loss of control of the driver 610. Unintentional steering movements or simple drifting away from the road can be the consequence. Oncoming obstacles may also not be recognized by the driver 610. The ADAS Emergency Overwrite Module 310 comprises a query a step 620 as to whether the takeover (“overwriting”) of the vehicle control by the ADAS system is safely possible. If this is not possible, the driver 610 is informed that the activation of the ADAS system (in-vehicle safety function to increase driving safety) is not possible. If the ADAS system of the vehicle is not able to take over control safely in the current situation, the driver should be notified that the system is currently unavailable. If it is possible, the ADAS Emergency Overwrite Module 310 hands over control of certain vehicle functions to the ADAS system during the determined first time period t_{blind} in a step 630. The driver 610 is no longer able to control the vehicle during the duration t_{blind}. Therefore, an emergency handover should be forced to the ADAS system of the vehicle. The ADAS system comprises, for example, lane keeping and adaptive cruise control (ACC) and activates them even if they are currently deactivated. In addition, all inputs of the driver should be ignored during the determined duration t_{blind}. To ensure safety, for example, a reduction of the vehicle speed is performed by the system 300 until the driver is again able to take over control of the vehicle. Furthermore, the driver assistance system emergency control system 310 can output a visual and/or acoustic notification to the driver 610 and inform the driver that control has been handed over to the ADAS system and when the system will return control to the driver 610.

So far, only the effect and detection of glare has been discussed, and how such a loss of control can be mitigated or prevented in an emergency. In the case of a self-glare by the own vehicle light, other countermeasures may be required than when glare is caused by a second vehicle.

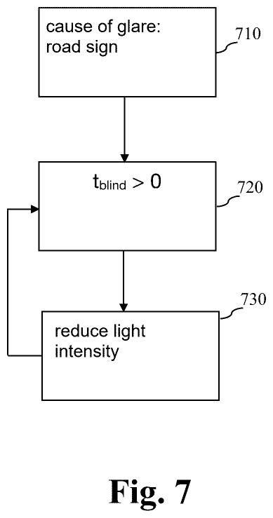

Self-glare can occur, for example, due to the reflection of the vehicle lights in highly reflective materials, such as, for example, some traffic lights. To reduce or eliminate these, we propose to adjust the light intensity such that no glare occurs in the presence of traffic lights. FIG. 7 shows, by way of example, the function of the light configurator 350 in the case of a self-glare. In step 710, the cause of the glare was determined as a reflection of the vehicle headlight at a road sign. In step 720, the remaining duration of the first time period t_{blind} is determined and it is checked whether this duration is greater than zero. If this is the case, the light configurator 350 issues to the light controllers 360 (light ECU) a request to reduce all or the LEDs responsible for the glare accordingly.

If the second vehicle 390 was identified as the glare cause, in some examples, the vehicle 510 can notify the second vehicle 390 by means of the V2X module 380 that the driver 610 was exposed to glare by the lights of the second vehicle 390. This can be used, for example, to force a switching off of the high beam of the second vehicle 390 or to control the intensity of the light. The V2X signals are forwarded to, for example, the light configurator and/or the light ECU of the second vehicle 390 in order to determine which LEDs should be deactivated or dimmed. The received signals/reports can also be used by the second vehicle 390 in order to identify incorrectly set lights. In some examples, this information is collected and used by an automobile manufacturer or a governmental entity to identify sources for glare situations and to take appropriate countermeasures to reduce the occurrence of these dangerous situations.

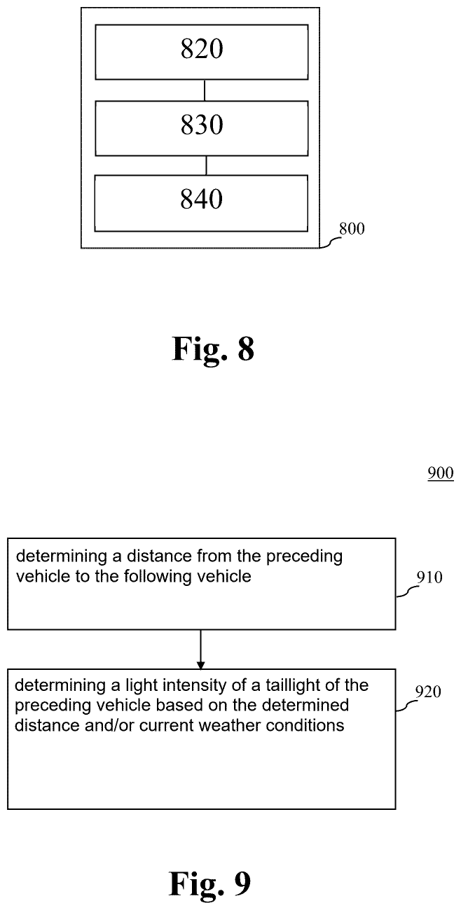

More details and aspects are mentioned in connection with the examples described above or below. The examples shown in FIG. 3-7 may include one or more optional additional features corresponding to one or more aspects mentioned in connection with the proposed concept or one or more examples described above (e.g., FIG. 1-2) or below (e.g., FIG. 8-13).

### Taillights

Since taillights may often be LED-based and thus very luminous, the driver of the following vehicle may be exposed to glare by the taillight of the preceding vehicle. Especially in the case of rain or poor weather conditions, the light intensity is often increased to ensure better and earlier visibility, whereby the driver of the following vehicle may be exposed to glare, especially when the following vehicle is very close, e.g., in a traffic jam. However, this glare results in discomfort and fatigue for the following drivers. The distance may therefore be determined by the device 800 depending on the distance to the following vehicle and depending on the weather conditions. The optimum illumination for the taillight may be determined on the basis of the distance to the following vehicle and the weather/visibility conditions.

FIG. 8 shows a block diagram of an example of a device 800 or apparatus 800 for minimizing the effects of glare of a following vehicle by a preceding vehicle. The device 800 comprises circuits configured to provide the functionality of the device 800. For example, the device 800 of FIG. 8 comprises (optionally) an interface circuit (interface) 820, a processing circuit (processor) 830, and (optionally) a memory circuit (memory) 840. The processing circuitry 830 may be coupled to, e.g., the interface circuitry 820 and optionally to the memory circuitry 840. The device 800 and the circuits of the device 800 may be implemented in the same manner as the device 100 and the circuits of the devices 100.

The processing circuit 830 is configured to determine a distance from the preceding vehicle to the following vehicle. The processing circuit 830 is further configured to determine a light intensity of a taillight of the preceding vehicle based on the determined distance and/or current weather conditions. For example, the light intensity of the taillight of the preceding vehicle is determined from the point of view of the preceding vehicle. The determined light intensity of one or more taillights of the preceding vehicle is transmitted, for example, to a light control unit (e.g., the light ECU 360) of the preceding vehicle, which adjusts the determined light intensity. The light intensity of the taillight can be precisely controlled in the taillight by adjusting individual LED segments.

In some examples, the processing circuit 830 has access to a model of the vehicle surroundings (e.g., ADAS environmental model 330) and/or a list of nearby road users as well as a map of the current road geometry. This information may also be included for determining the distance.

For example, the processing circuit 830 may determine the distance between the preceding vehicle and the following vehicle by means of various sensors. For example, the distance from the point of view of the preceding vehicle may be determined with one or more environmental sensors of the preceding vehicle. The one environmental sensor may be configured as a radar, lidar, ultrasound, or camera sensor as described above.

The weather conditions may be determined by a combination of various environmental sensors of the preceding and/or following vehicle and obtained from an external entity such as a weather service. For example, a rain sensor may be used which is attached to the windshield and which detects the amount and intensity of the precipitation. Furthermore, fog sensors may evaluate the visual range by analyzing the light scattering in the atmosphere. Temperature sensors measure the outside temperature in order to estimate the risk of ice or snow. Light sensors detect the ambient brightness and distinguish between daylight and artificial illumination at night. Together, these sensors provide continuous data about the current weather conditions.

For example, the light intensity between a minimum value and a maximum value may increase linearly with the distance from the preceding vehicle to the following vehicle. The light intensity thus determined may then be weighted with a weather ratio factor. For example, the weather ratio factor may assume the values 0.5, 1 and 1.5. The value of 0.5 may be assumed in poor weather conditions, the value of 1 may be assumed in normal weather conditions and the value of 1.5 may be assumed in good weather conditions.

In some examples, the light intensity of the taillight of the preceding vehicle is set to a maximum light intensity value if the determined distance exceeds a first threshold. If the following vehicle is very far away, the risk of glare is low and the maximum light intensity may be set. For example, the processing circuit 830 performs the setting (e.g., the light ECU).

In some examples, the light intensity of the taillight of the preceding vehicle is set to a minimum light intensity value if the determined distance falls below a second threshold. If the following vehicle is very closely present, the risk of glare is very high and only a minimum light intensity may be set. For example, the processing circuit 830 performs the setting (e.g., the light ECU).

In some examples, the light intensity of the taillight of the preceding vehicle may be set between a maximum light intensity value and a minimum light intensity value if the distance exceeds the second threshold. For example, the processing circuit 830 performs the setting (e.g., the light ECU).

For example, the light intensity iₜₐᵢₗ may be determined as follows:

$${i}_{tail} = - \{ \begin{matrix}{i}_{max} , if d > {d}_{max} \\ min ( {i}_{min} + {i}_{max} * \frac{d - {d}_{min}}{{d}_{max}} * {α}_{vis} , {i}_{max} ) , if d > {d}_{min} \\ {i}_{min} * {α}_{vis} , else\end{matrix} \qquad ( 5 )$$

Here, iₘₐₓ is the maximum light intensity value and iₘᵢₙ is the minimum light intensity value, αᵥᵢₛ is the weather ratio factor and d is the distance from the preceding vehicle to the following vehicle and dₘᵢₙ is the second threshold and dₘₐₓ is the first threshold.

In an example, the processing circuit 830 may be further configured to determine an increased distance between the following vehicle and the preceding vehicle based on the light intensity of the tail light of the preceding vehicle, if the light intensity of the tail light of the preceding vehicle exceeds a third threshold. For example, the processing circuit 830 may increase the distance from the point of view of the following vehicle, if the taillight has too strong a light intensity. For example, the controllers of the following vehicle may perform the distance increase.

More details and aspects are mentioned in connection with the examples described above or below. The example shown in FIG. 8 may include one or more optional additional features corresponding to one or more aspects mentioned in connection with the proposed concept or one or more examples described above (e.g., FIG. 1-7) or below (e.g., FIG. 9-13).

FIG. 9 shows a flowchart of an example of a method 900 for minimizing the effects of glare of a following vehicle by a preceding vehicle. The method 900 may be performed, for example, by a device described herein, such as the device 800. The method includes determining 910 a distance from the preceding vehicle to the following vehicle. The method 900 further includes determining 920 a light intensity of a taillight of the preceding vehicle based on the determined distance and/or current weather conditions.

Further details and aspects of the method 900 are explained in connection with the proposed technology or one or more examples described above, e.g., with reference to FIG. 8. Method 900 may comprise one or more additional optional features corresponding to one or more aspects of the proposed technology or one or more examples described above.

### Front Headlight

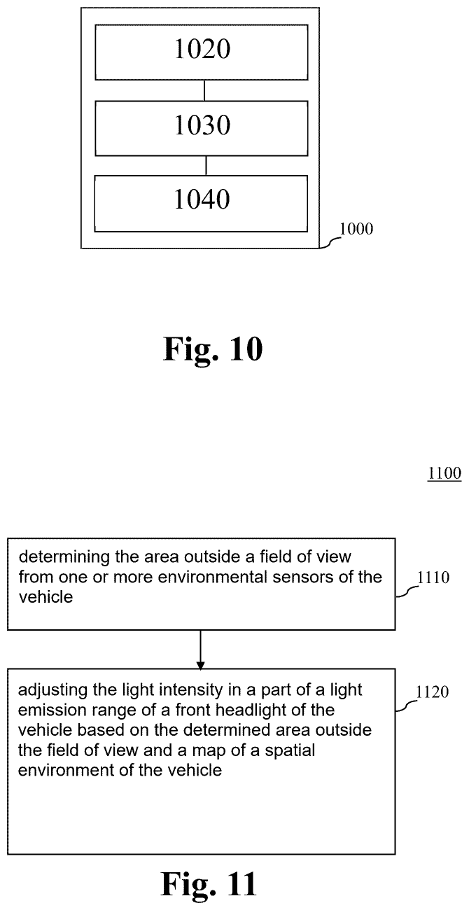

FIG. 10 shows a block diagram of an example of a device 1000 or an apparatus 1000 for minimizing the effects of glare in an area outside the field of view of a vehicle. The device 1000 comprises circuits configured to provide the functionality of the device 1000. For example, the device 1000 of FIG. 10 comprises (optionally) an interface circuit (interface) 820, a processing circuit (processor) 1030, and (optionally) a memory circuit (memory) 1040. The processing circuitry 1030 may be coupled to, e.g., the interface circuitry 1020 and optionally to the memory circuitry 1040. The device 1000 and the circuits of the device 1000 may be implemented in the same manner as the device 100 and the circuits of the devices 100.

The processing circuit 1030 is configured to determine the area outside a field of view from one or more environmental sensors of the vehicle. The processing circuit 1030 is further configured to adjust the light intensity in a part of a light emission range of a front headlight of the vehicle based on the determined area outside the field of view and a map of a spatial environment of the vehicle. In some examples, the processing circuit 1030 has access to a model of the vehicle surroundings (e.g., ADAS environmental model 330) and/or a list of nearby road users as well as a map of the current road geometry.

The map of the spatial environment of the vehicle may be created by a combination of real-time data and pre-stored information. Real-time data originates from the environmental sensors of the vehicle, such as lidar, radar, and cameras, which continuously scan the environment and create updated 3D models of the environment. Pre-stored information may be received from external sources, such as GPS databases and map services, which provide detailed maps of roads, terrain shapes, and infrastructure. This data is integrated into the processing circuit 1030 and merged into a comprehensive, current map of the surroundings of the vehicle. In another example, the map of the spatial environment of the vehicle is created by an external service of the processing circuit 1030, for example, received via the interface 1020.

The known vehicle sensor configuration refers, for example, to the specific arrangement and coverage areas of the various sensors installed on the vehicle. This includes, for example, details about what types of sensors are used, where they are attached to the vehicle, and what areas they can monitor.

Based on the map of the spatial environment of the vehicle and the known vehicle sensor configuration, the processing circuit 1030 may determine areas outside the field of view of the sensors. To do so, it compares the captured data of the sensors with the comprehensive surroundings map to determine which areas are not covered by the sensors. This analysis identifies occluded areas and areas outside the sensor field of view, such as those occluded by topographic features such as hills or height differences. By precisely determining these areas, the processing circuit may take actions such as adjusting the headlight illumination.

Based on the map of the spatial environment of the vehicle (e.g., ADAS surroundings model 330) and the known vehicle sensor configuration, the processing circuit 1030 determines an area outside the field of view from one or more environmental sensors of the vehicle (e.g., occluded areas and areas outside the sensor field of view (e.g., due to a crest, a height difference, etc.)). As road users may be in this area outside the field of view (areas which are not visible), the light intensity for these areas will be proactively reduced to avoid glare.

More details and aspects are mentioned in connection with the examples described above or below. The example shown in FIG. 10 may include one or more optional additional features corresponding to one or more aspects mentioned in connection with the proposed concept or one or more examples described above (e.g., FIG. 1-9) or below (e.g., FIG. 11-13).

FIG. 11 shows a flowchart of an example of a method 1100 for minimizing the effects of glare in an area outside the field of view of a vehicle. The method 1100 may be performed, for example, by a device described herein, such as the device 1000. The method includes determining 1110 determining the area outside a field of view from one or more environmental sensors of the vehicle. The method 1100 further includes adjusting the light intensity in a part of a light emission range of a front headlight of the vehicle based on the determined area outside the field of view and a map of a spatial environment of the vehicle.

Further details and aspects of the method 1100 are explained in connection with the proposed technology or one or more examples described above, e.g., with reference to FIG. 10. Method 1100 may comprise one or more additional optional features corresponding to one or more aspects of the proposed technology or one or more examples described above.

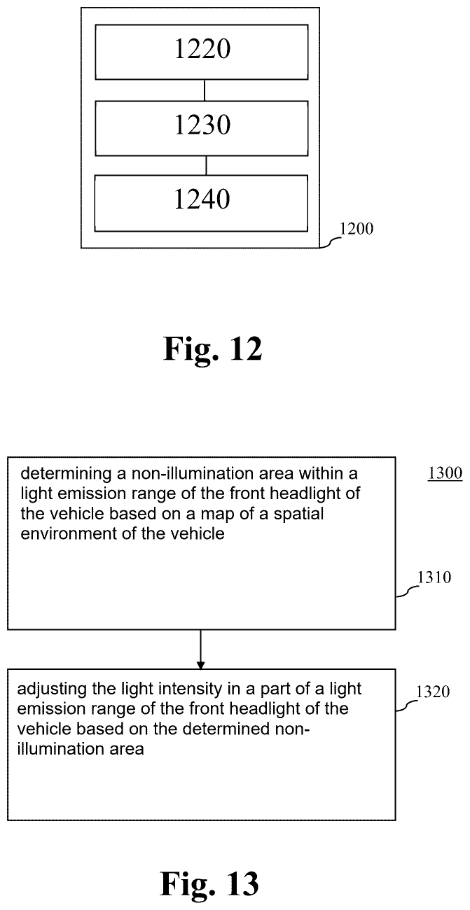

FIG. 12 shows a block diagram of an example of a device 1200 or an apparatus 1200 for adjusting a light intensity of a front headlight of a vehicle. The device 1200 comprises circuits configured to provide the functionality of the device 1200. For example, the device 1200 of FIG. 12 comprises (optionally) an interface circuit (interface) 1220, a processing circuit (processor) 1230, and (optionally) a memory circuit (memory) 1240. The processing circuitry 1230 may be coupled to, e.g., the interface circuitry 1220 and optionally to the memory circuitry 1240. The device 1200 and the circuits of the device 1200 may be implemented in the same manner as the device 100 and the circuits of the devices 100.

The processing circuit 1230 is configured to determine a non-illumination area within a light emission range of the front headlight of the vehicle based on a map of a spatial environment of the vehicle. The processing circuit 1230 is further configured to adjust the light intensity in a part of a light emission range of the front headlight of the vehicle based on the determined non-illumination area.

In some examples, an area within the light emission range of the front headlight of the vehicle may be determined as a non-illumination area if a relevance value of this area to the driver is below a certain threshold.

A non-illumination area within a light emission range of the front headlight of the vehicle may be, for example, an area that could be illuminated by a front headlight of the vehicle but that intentionally is not illuminated. The processing circuit 1230 is configured to determine such areas by analyzing a map of the spatial environment of the vehicle. This map contains detailed information about the road conditions, buildings, obstacles, and other relevant objects in the surroundings. By matching this map with the current sensor data, the processing circuit identifies areas that are not critical to the driving situation and thus do not need to be illuminated (determining the map as described above). An area within the light emission range of the front headlight may be determined as a non-illumination area if its relevance value to the driver is below a certain threshold. The relevance value may be determined by various factors such as the current driving speed, the position and direction of movement of the vehicle as well as the environmental context such as road course and traffic conditions. For example, on the freeway, the light intensity for areas above the road may be reduced unless there are traffic signs the location of which is known from the map. In such cases, the corresponding LEDs could be dimmed or switched off if there is no traffic sign at a reasonable distance. For example, open fields or undeveloped areas next to the road may obtain a relevance value of below 1 since they do not provide safety relevant information and the threshold could be 1. In these cases, the light intensity could be reduced to save energy and avoid glare. In contrast, critical areas such as the road or potential danger zones, such as a sharp curve or a pedestrian crossing, could obtain a high relevance value of above 1 and therefore need to remain optimally illuminated to ensure safe navigation.

For example, the processing circuit 1230 adds these determined relevance values to the map of the spatial environment of the vehicle by assigning specific values to each area based on factors such as road course, obstacles, and potential danger zones. These relevance values reflect the importance of illumination for driving safety, with lower values standing for less critical areas such as open fields or undeveloped areas and higher values standing for safety relevant zones such as roads and pedestrian crossings. Once these relevance values are assigned, the processing circuit 1230 compares this map with the light emission range of the front headlights and the defined threshold. Based on this comparison, it adjusts the light intensity such that areas with low relevance values are illuminated less intensively or not at all, while critical areas with high relevance values remain optimally illuminated to ensure driving safety. The processing circuit 1230 adjusts the light intensity in certain parts of the light emission range of the front headlight based on the identified non-illumination areas. This means that it selectively dims or switches off the light source in these areas. This is achieved by controlling adaptive headlights equipped with numerous LEDs or segmented light sources. The processing circuit regulates the power supply to these light sources to dynamically adjust the light distribution and ensure that only the relevant areas are optimally illuminated.

More details and aspects are mentioned in connection with the examples described above or below. The example shown in FIG. 12 may include one or more optional additional features corresponding to one or more aspects mentioned in connection with the proposed concept or one or more examples described above (e.g., FIG. 1-11) or below (e.g., FIG. 13).

FIG. 13 shows a flowchart of an example of a method 1300 for adjusting a light intensity of a front headlight of a vehicle. The method 1300 may be performed, for example, by a device described herein, such as the device 1200. The method includes determining 1310 a non-illumination area within a light emission range of the front headlight of the vehicle based on a map of a spatial environment of the vehicle. The method 1300 further includes adjusting 1320 the light intensity in a part of a light emission range of the front headlight of the vehicle based on the determined non-illumination area.

Further details and aspects of the method 1300 are explained in connection with the proposed technology or one or more examples described above, e.g., with reference to FIG. 12. Method 1300 may comprise one or more additional optional features corresponding to one or more aspects of the proposed technology or one or more examples described above.

Further, a vehicle including any of the devices of FIG. 1-7, 8, 10, 12 and/or means for performing any of the methods of FIG. 2, 9, 11, 13 is disclosed.

In the following, some examples of the proposed concept are presented:

An example (e.g., example 1) relates to a device for minimizing the effects of glare of a driver of a vehicle, the device comprising a circuit configured to determine a glare intensity of the glare of the driver of the vehicle; if the glare intensity exceeds a threshold, activate an in-vehicle safety function to increase driving safety in the presence of glare.

An example (e.g., example 2) relates to a preceding example (e.g., example 1), wherein activating the in-vehicle safety function to increase driving safety comprises activating a driver assistance system or autonomous driving system, and wherein the driver assistance system or autonomous driving system controls at least one function of the vehicle during a first time period.

An example (e.g., example 3) relates to a preceding example (e.g., any of examples 1 to 2), wherein activating the driver assistance system or autonomous driving system comprises activating an adaptive cruise control of a lane keeping assistant and/or an emergency braking assistant.

An example (e.g., example 4) relates to a preceding example (e.g., any of examples 2 to 3), wherein the circuit is further configured to block control commands of the driver with respect to the at least one function of the vehicle during activating the driver assistance system or autonomous driving system for the duration of the first time period.

An example (e.g., example 5) relates to a preceding example (e.g., any of examples 2 to 4), wherein the driver assistance system comprises a driver assistance system emergency control system or the autonomous driving system comprises an autonomous driving emergency control system.

An example (e.g., example 6) relates to a preceding example (e.g., any of examples 2 to 5), wherein the circuit is further configured to determine the first time period based on the glare intensity, a previous glare load of the driver, a predicted duration of the glare of the driver and/or a glare recovery duration of the driver.

An example (e.g., example 7) relates to a preceding example (e.g., example 6), wherein the circuit is further configured to determine the predicted duration of the glare of the driver based on a cause of the glare of the driver.

An example (e.g., example 8) relates to a preceding example (e.g., any of examples 1 to 7), wherein the circuit is further configured to determine the cause of the glare of the driver.

An example (e.g., example 9) relates to a preceding example (e.g., example 8), wherein determining the cause of the glare of the driver is based on data of at least one environmental sensor of the vehicle.

An example (e.g., example 10) relates to a preceding example (e.g., example 8), wherein determining the cause of the glare of the driver is based on data of at least one vehicle assistance system sensor.

An example (e.g., example 11) relates to a preceding example (e.g., any of examples 8 to 10), wherein activating the in-vehicle safety function to increase driving safety comprises adjusting a light intensity in a part of a light emission range of a headlight of the vehicle if a self-glare by the vehicle has been determined as the cause of the glare of the driver.

An example (e.g., example 12) relates to a preceding example (e.g., any of examples 1 to 11), wherein the circuit is further configured to inform a second vehicle about the determined glare intensity.

An example (e.g., example 13) relates to a preceding example (e.g., any of examples 1 to 12), wherein determining the glare intensity is based on a state of the pupil opening of the driver, a blink frequency of the driver, a gaze direction of the driver, a glare protection gesture of the driver, a presence of tears in an eye of the driver and/or information about the surroundings of the vehicle.

An example (e.g., example 14) relates to a preceding example (e.g., example 13), wherein determining the glare intensity is based on a weighted combination of the state of the pupil opening of the driver, the blink frequency of the driver, the gaze direction of the driver, the glare protection gesture of the driver, the presence of tears in an eye of the driver and/or information about the surroundings of the vehicle.

An example (e.g., example 15) relates to a preceding example (e.g., any of examples 13 to 14), wherein determining the glare intensity is based on a machine learning algorithm and the state of the pupil opening of the driver, the blink frequency of the driver, the gaze direction of the driver, the glare protection gesture of the driver, the presence of tears in an eye of the driver and/or information about the surroundings of the vehicle.

An example (e.g., example 16) relates to a preceding example (e.g., any of examples 13 to 15), wherein the circuit is further configured to determine a state of the pupil opening of the driver, a blink frequency of the driver, a gaze direction of the driver, a glare protection gesture of the driver and/or a presence of tears in an eye of the driver based on data of at least one sensor inside the vehicle directed at the driver.

An example (e.g., example 17) relates to a preceding example (e.g., any of examples 13 to 16), wherein the circuit is further configured to determine information about the surroundings of the vehicle based on at least one environmental sensor of the vehicle.

An example (e.g., example 18) relates to a preceding example (e.g., any of examples 13 to 17), wherein the circuit is further configured to determine a state of the pupil opening of the driver, a blink frequency of the driver, a gaze direction of the driver, a glare protection gesture of the driver, a presence of tears in an eye of the driver and/or to determine information about the surroundings of the vehicle based on a machine learning algorithm.

An example (e.g., example 19) relates to a method for minimizing the effects of glare of a driver of a vehicle, the method comprising: determine a glare intensity of the glare of the driver of the vehicle; if the glare intensity exceeds a threshold, activating an in-vehicle safety function to increase driving safety in the presence of glare.

An example (e.g., example 20) relates to a preceding example (e.g., example 19), wherein activating the in-vehicle safety function to increase driving safety comprises activating a driver assistance system or autonomous driving system, and wherein the driver assistance system or autonomous driving system controls at least one function of the vehicle during a first time period.

An example (e.g., example 21) relates to a preceding example (e.g., example 20), wherein activating the driver assistance system or autonomous driving system comprises activating an adaptive cruise control of a lane keeping assistant and/or an emergency braking assistant.

An example (e.g., example 22) relates to a preceding example (e.g., any of examples 20 to 21), further comprising blocking control commands of the driver with respect to the at least one function of the vehicle during activating the driver assistance system or autonomous driving system for the duration of the first time period.

An example (e.g., example 23) relates to a preceding example (e.g., any of examples 20 to 22), wherein the driver assistance system comprises a driver assistance system emergency control system or the autonomous driving system comprises an autonomous driving emergency control system.

An example (e.g., example 24) relates to a preceding example (e.g., any of examples 20 to 23), further comprising determining the first time period based on the glare intensity, a previous glare load of the driver, a predicted duration of the glare of the driver and/or a glare recovery duration of the driver.

An example (e.g., example 25) relates to a preceding example (e.g., example 24), further comprising determining the predicted duration of the glare of the driver based on a cause of the glare of the driver.

An example (e.g., example 26) relates to a preceding example (e.g., any of examples 19 to 25), further comprising determining the cause of the glare of the driver.

An example (e.g., example 27) relates to a preceding example (e.g., example 26), wherein determining the cause of the glare of the driver is based on data of at least one environmental sensor of the vehicle.

An example (e.g., example 28) relates to a preceding example (e.g., example 26), wherein determining the cause of the glare of the driver is based on data of at least one vehicle assistance system sensor.

An example (e.g., example 29) relates to a preceding example (e.g., any of examples 26 to 28), wherein activating the in-vehicle safety function to increase driving safety comprises adjusting a light intensity in a part of a light emission range of a headlight of the vehicle if a self-glare by the vehicle has been determined as the cause of the glare of the driver.

An example (e.g., example 30) relates to a preceding example (e.g., any of examples 19 to 29), further comprising informing a second vehicle about the determined glare intensity.

An example (e.g., example 31) relates to a preceding example (e.g., any of examples 19 to 30), wherein determining the glare intensity is based on a state of the pupil opening of the driver, a blink frequency of the driver, a gaze direction of the driver, a glare protection gesture of the driver, a presence of tears in an eye of the driver and/or information about the surroundings of the vehicle.

An example (e.g., example 32) relates to a preceding example (e.g., example 31), wherein determining the glare intensity is based on a weighted combination of the state of the pupil opening of the driver, the blink frequency of the driver, the gaze direction of the driver, the glare protection gesture of the driver, the presence of tears in an eye of the driver and/or information about the surroundings of the vehicle.

An example (e.g., example 33) relates to a preceding example (e.g., any of examples 31 to 32), wherein determining the glare intensity is based on a machine learning algorithm and the state of the pupil opening of the driver, the blink frequency of the driver, the gaze direction of the driver, the glare protection gesture of the driver, the presence of tears in an eye of the driver and/or information about the surroundings of the vehicle.

An example (e.g., example 34) relates to a preceding example (e.g., any of examples 31 to 33), further comprising determining a state of the pupil opening of the driver, a blink frequency of the driver, a gaze direction of the driver, a glare protection gesture of the driver and/or a presence of tears in an eye of the driver based on data of at least one sensor inside the vehicle directed at the driver.

An example (e.g., example 35) relates to a preceding example (e.g., any of examples 31 to 34), further comprising determining information about the surroundings of the vehicle based on at least one environmental sensor of the vehicle.

An example (e.g., example 36) relates to a preceding example (e.g., any of examples 31 to 35), further comprising determining a state of the pupil opening of the driver, a blink frequency of the driver, a gaze direction of the driver, a glare protection gesture of the driver, a presence of tears in an eye of the driver and/or to determine information about the surroundings of the vehicle based on a machine learning algorithm.

An example (e.g., example 37) relates to a device for minimizing the effects of glare of a following vehicle by a preceding vehicle, the device comprising: a circuit configured to:
determine a distance from the preceding vehicle to the following vehicle;
determine a light intensity of a taillight of the preceding vehicle based on the determined distance and/or current weather conditions.

An example (e.g., example 38) relates to a preceding example (e.g., example 37), wherein, if the determined distance exceeds a first threshold, the light intensity of the taillight of the preceding vehicle assumes a maximum light intensity value.

An example (e.g., example 39) relates to a preceding example (e.g., any of examples 37 to 38), wherein, if the distance exceeds a second threshold, the light intensity of the tail light of the preceding vehicle is between a maximum light intensity value and a minimum light intensity value.

An example (e.g., example 40) relates to a preceding example (e.g., any of examples 37 to 39), wherein the circuit is further configured to determine an increased distance between the following vehicle and the preceding vehicle based on the light intensity of the tail light of the preceding vehicle, if the light intensity of the tail light of the preceding vehicle exceeds a third threshold.

An example (e.g., example 41) relates to a method for minimizing the effects of glare of a following vehicle by a preceding vehicle, comprising:
determine a distance from the preceding vehicle to the following vehicle;
determine a light intensity of a taillight of the preceding vehicle based on the determined distance and/or current weather conditions.

An example (e.g., example 42) relates to a preceding example (e.g., example 41), wherein, if the determined distance exceeds a first threshold, the light intensity of the taillight of the preceding vehicle assumes a maximum light intensity value.

An example (e.g., example 43) relates to a preceding example (e.g., any of examples 41 to 42), wherein, if the distance exceeds a second threshold, the light intensity of the tail light of the preceding vehicle is between a maximum light intensity value and a minimum light intensity value.

An example (e.g., example 44) relates to a preceding example (e.g., any of examples 41 to 43), further comprising determining an increased distance between the following vehicle and the preceding vehicle based on the light intensity of the tail light of the preceding vehicle, if the light intensity of the tail light of the preceding vehicle exceeds a third threshold.

An example (e.g., example 45) relates to a device for minimizing the effects of glare in an area outside the field of view of a vehicle, the device comprising:
a circuit configured to:
determine the area outside a field of view from one or more environmental sensors of the vehicle;
adjust the light intensity in a part of a light emission range of a front headlight of the vehicle based on the determined area outside the field of view and a map of a spatial environment of the vehicle.

An example (e.g., example 46) relates to a method for minimizing the effects of glare in an area outside the field of view of a vehicle, comprising: determining the area outside a field of view from one or more environmental sensors of the vehicle; adjusting the light intensity in a part of a light emission range of a front headlight of the vehicle based on the determined area outside the field of view and a map of a spatial environment of the vehicle.

An example (e.g., example 47) relates to a device for adjusting a light intensity of a front headlight of a vehicle, the device comprising:
a circuit configured to:
determine a non-illumination area within a light emission range of the front headlight of the vehicle based on a map of a spatial environment of the vehicle;
adjust the light intensity in a part of a light emission range of the front headlight of the vehicle based on the determined non-illumination area.

An example (e.g., example 48) relates to a preceding example (e.g., example 47), wherein an area within the light emission range of the front headlight of the vehicle is determined as a non-illumination area if a relevance value of this area to the driver is below a certain threshold.

An example (e.g., example 49) relates to a method for adjusting a light intensity of a front headlight of a vehicle, comprising:
determining a non-illumination area within a light emission range of the front headlight of the vehicle based on a map of a spatial environment of the vehicle;
adjusting the light intensity in a part of a light emission range of the front headlight of the vehicle based on the determined non-illumination area.

An example (e.g., example 50) relates to a preceding example (e.g., example 49), wherein an area within the light emission range of the front headlight of the vehicle is determined as a non-illumination area if a relevance value of this area to the driver is below a certain threshold.

An example (e.g., example 51) relates to a device comprising an interface circuit, machine-readable instructions, and a processing circuit for executing the machine-readable instructions to:
determine a glare intensity of the glare of the driver of the vehicle;
if the glare intensity exceeds a threshold, activate an in-vehicle safety function to increase driving safety in the presence of glare.

An example (e.g., example 52) relates to a device comprising means to:
determine a glare intensity of the glare of the driver of the vehicle;
if the glare intensity exceeds a threshold, activate an in-vehicle safety function to increase driving safety in the presence of glare.

An example (e.g., example 53) relates to a non-transitory machine-readable storage medium containing program code that, when executed, causes a machine to perform any of the methods of any of examples 19 to 36, 41 to 44, 46, 49 to 50.

An example (e.g., example 54) relates to a computer program having a program code for performing any of the methods of any of examples 19 to 36, 41 to 44, 46, 49 to 50 when the computer program is executed on a computer, a processing circuit, or a programmable hardware component.

An example (e.g., example 55) relates to a machine-readable storage containing machine-readable instructions to, when executed, implement a method or implement a device as claimed in any of the pending examples.

The aspects and features described in relation to a particular one of the previous examples may also be combined with one or more of the further examples to replace an identical or similar feature of that further example or to additionally introduce the feature into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or comprise machine-executable, processor-executable or computer-executable programs and instructions. The program storage devices may comprise or be, for instance, digital memories, magnetic storage media such as magnetic disks and magnetic tapes, hard drives, or optically readable digital data storage media. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects in the previous sections have been described in relation to a device or system, these aspects should also be understood as a description of the corresponding method. In this case, for example, a block, an apparatus or a functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, to software or firmware running on a processing unit, or to a combination thereof to perform one or more operations consistent with the present disclosure. Software and firmware may be embodied in the form of instructions and/or data stored on non-transitory computer-readable storage media. As used herein, the term “circuit” may include, individually or in any combination, non-programmable (hardwired) circuits, programmable circuits such as processing units, state machine circuits, and/or firmware storing instructions executable by programmable circuits. The modules described herein may be collectively or individually embodied as circuits that form part of a computer system. Thus, each of the modules may be implemented as a circuitry. A computer system programmed to perform a method may be programmed to perform the method via software, hardware, firmware, or combinations thereof.

Each of the disclosed methods (or a part thereof) may be implemented as computer-executable instructions or a computer program product. Such instructions may cause a computer system or one or more processing units capable of executing computer-executable instructions to perform any of the disclosed methodologies. As used herein, the term “computer” refers to any computer system or device described or mentioned herein. Thus, the term “computer-executable instruction” refers to instructions that may be executed by any computer system or device described or mentioned herein.

The computer-executable instructions may be, for example, part of an operating system of the computer system, an application stored locally on the computer system, or a remote application accessible to the computer system (e.g., via a web browser). Each of the methods described herein may be performed by computer-executable instructions executed by a single computer system or one or more networked computer systems operating in a networking environment. Computer-executable instructions and updates to the computer-executable instructions may be downloaded to a computer system from a remote server.

It is to be understood that the implementation of the disclosed technologies is not limited to any particular computer language or program. For example, the disclosed technologies may be implemented by software written in C++, C #, Java, Perl, Python, JavaScript, Adobe Flash, C #, assembly language, or any other programming language. Likewise, the disclosed technologies are not limited to any particular computer system or hardware type.

Moreover, any of the software-based examples (e.g., including computer-executable instructions that cause a computer to perform any of the disclosed methods) may be uploaded, downloaded, or remotely accessed via any suitable communication means. Such suitable communication means include, for example, the Internet, the World Wide Web, an intranet, cable (including fiber optic cable), magnetic communication, electromagnetic communication (including RF, microwave, ultrasonic, and infrared communication), electronic communication, or any other such communication means.

The disclosed methodologies, devices, and systems should in no way be construed as limiting. Rather, the present disclosure is directed to all novel and non-obvious features and aspects of the various disclosed examples, both alone and in various combinations and sub-combinations with one another. The disclosed methodologies, devices, and systems are not limited to any particular aspect or feature, or combination thereof, and the disclosed examples also do not require one or more particular advantages or problems to be solved.

Operating theories, scientific principles, or other theoretical descriptions presented herein with respect to the apparatus or methods of this disclosure are provided for ease of understanding and are not intended to limit the scope of application. The devices and methods recited in the appended claims are not limited to such devices and methods that function in the manner described in these operating theories.

The following claims are hereby incorporated in the detailed description, wherein each claim may stand on its own as a separate example. It should also be noted that—although in the claims a dependent claim refers to a particular combination with one or more other claims—other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. A device for minimizing effects of glare of a driver of a vehicle, the device comprising an interface circuit, machine-readable instructions, and a processing circuit for executing the machine-readable instructions to:
determine a glare intensity of the glare of the driver of the vehicle; and
if the glare intensity exceeds a threshold, activate an in-vehicle safety function to increase driving safety in the presence of glare.

2. The device of claim 1, wherein activating the in-vehicle safety function to increase driving safety comprises activating a driver assistance system or autonomous driving system, and wherein the driver assistance system or autonomous driving system controls at least one function of the vehicle during a first time period.

3. The device of claim 2, wherein activating the driver assistance system or autonomous driving system comprises activating an adaptive cruise control of a lane keeping assistant and/or an emergency braking assistant.

4. The device of claim 2, wherein the processing circuit is further to execute the machine-readable instructions to block control commands of the driver with respect to the at least one function of the vehicle during activating the driver assistance system or autonomous driving system for the duration of the first time period.

5. The device of claim 2, wherein the driver assistance system comprises a driver assistance system emergency control system or the autonomous driving system comprises an autonomous driving emergency control system.

6. The device of claim 2, wherein the processing circuit is further to execute the machine-readable instructions to determine the first time period based on the glare intensity, a previous glare load of the driver, a predicted duration of the glare of the driver and/or a glare recovery duration of the driver.

7. The device of claim 6, wherein the processing circuit is further to execute the machine-readable instructions to determine the predicted duration of the glare of the driver based on a cause of the glare of the driver.

8. The device of claim 1, wherein the circuit is further configured to determine the cause of the glare of the driver.

9. The device of claim 8, wherein determining the cause of the glare of the driver is based on data of at least one environmental sensor of the vehicle.

10. The device of claim 8, wherein determining the cause of the glare of the driver is based on data of at least one vehicle assistance system sensor.

11. The device of claim 8, wherein activating the in-vehicle safety function to increase driving safety comprises adjusting a light intensity in a part of a light emission range of a headlight of the vehicle if a self-glare by the vehicle has been determined as the cause of the glare of the driver.

12. The device of claim 1, wherein the processing circuit is further to execute the machine-readable instructions to inform a second vehicle about the determined glare intensity.

13. The device of claim 1, wherein determining the glare intensity is based on a state of the pupil opening of the driver, a blink frequency of the driver, a gaze direction of the driver, a glare protection gesture of the driver, a presence of tears in an eye of the driver and/or information about the surroundings of the vehicle.

14. The device of claim 13, wherein determining the glare intensity is based on a weighted combination of the state of the pupil opening of the driver, the blink frequency of the driver, the gaze direction of the driver, the glare protection gesture of the driver, the presence of tears in an eye of the driver and/or information about the surroundings of the vehicle.

15. The device of claim 13, wherein determining the glare intensity is based on a machine learning algorithm and the state of the pupil opening of the driver, the blink frequency of the driver, the gaze direction of the driver, the glare protection gesture of the driver, the presence of tears in an eye of the driver and/or information about the surroundings of the vehicle.

16. The device of claim 13, wherein the processing circuit is further to execute the machine-readable instructions to determine a state of the pupil opening of the driver, a blink frequency of the driver, a gaze direction of the driver, a glare protection gesture of the driver and/or a presence of tears in an eye of the driver based on data of at least one sensor inside the vehicle directed at the driver.

17. The device of claim 13, wherein the processing circuit is further to execute the machine-readable instructions to determine information about the surroundings of the vehicle based on at least one environmental sensor of the vehicle.

18. The device of claim 13, wherein the processing circuit is further to execute the machine-readable instructions to determine a state of the pupil opening of the driver, a blink frequency of the driver, a gaze direction of the driver, a glare protection gesture of the driver, a presence of tears in an eye of the driver and/or to determine information about the surroundings of the vehicle based on a machine learning algorithm.

19. A method for minimizing effects of glare of a driver of a vehicle, the method comprising:
determining a glare intensity of the glare of the driver of the vehicle; and
if the glare intensity exceeds a threshold, activating an in-vehicle safety function to increase driving safety in the presence of glare.

20. A device for minimizing effects of glare in an area outside a field of view of a vehicle, the device comprising an interface circuit, machine-readable instructions, and a processing circuit for executing the machine-readable instructions to:
determine the area outside a field of view from one or more environmental sensors of the vehicle; and
adjust light intensity in a part of a light emission range of a front headlight of the vehicle based on the determined area outside the field of view and a map of a spatial environment of the vehicle.
